(19) United States
(12) Patent Application Publication
(10) Pub. No.: US 2026/0148884 A1
(43) Pub. Date: May 28, 2026

(54) R-T-B BASED PERMANENT MAGNET AND METHOD OF MANUFACTURING THE SAME

(71) Applicant: TDK CORPORATION, Tokyo (JP)

(72) Inventors: Takuma HAYAKAWA, Tokyo (JP); Shingo KONDO, Tokyo (JP)

(73) Assignee: TDK CORPORATION, Tokyo (JP)

(21) Appl. No.: 19/401,791

(22) Filed: Nov. 26, 2025

(30) Foreign Application Priority Data
Nov. 27, 2024 (JP) 2024-206387
Nov. 4, 2025 (JP) 2025-185991

(51) Int. Cl. H01F 1/057; B22F 1/142; B22F 3/16; B22F 3/24; B22F 9/02; B22F 9/04; C22C 38/00; C22C 38/06; C22C 38/14; C22C 38/16

(52) U.S. Cl. CPC H01F 1/0577; B22F 1/142; B22F 3/16; B22F 3/24; B22F 9/023; B22F 9/04; C22C 38/001; C22C 38/002; C22C 38/005; C22C 38/06; C22C 38/14; C22C 38/16; B22F 2003/241; B22F 2003/248; B22F 2009/044; B22F 2201/03; B22F 2201/10; B22F 2301/355; B22F 2998/10; B22F 2999/00; C22C 2202/02

(57) ABSTRACT

An R-T-B based permanent magnet contains a rare earth element, Fe, Zr, Cu, B, C, O, and N. The magnet contains 28.50 mass % or more and 32.00 mass % or less rare earth element, 0.01 mass % or more and 0.50 mass % or less Zr, 0.04 mass % or more and 0.50 mass % or less Cu, 0 mass % or more and 0.60 mass % or less Al, 0 mass % or more and 0.80 mass % or less Ga, 0 mass % or more and 3.50 mass % or less Co, 0.88 mass % or more and 1.00 mass % or less B, 0.05 mass % or more and 0.12 mass % or less C, 0.11 mass % or more and 0.30 mass % or less O, 0.015 mass % or more and 0.07 mass % or less N, and Fe substantially constituting a balance. The magnet contains 0.03 mass % or more and 0.20 mass % or less heavy rare earth element.

### TECHNICAL FIELD

The present disclosure relates to an R-T-B based permanent magnet and a method of manufacturing the same.

### BACKGROUND

Patent Document 1 discloses an R-T-B based permanent magnet having improved magnetic properties by having a composition within a specific range.

Patent Document 1: JP Patent Application Laid Open No. 2022-8212

### SUMMARY

An R-T-B based permanent magnet according to the present disclosure contains a rare earth element, Fe, Zr, Cu, B, C, O, and N,
wherein
the R-T-B based permanent magnet contains
   28.50 mass % or more and 32.00 mass % or less rare earth element,
   0.01 mass % or more and 0.50 mass % or less Zr,
   0.04 mass % or more and 0.50 mass % or less Cu,
   0 mass % or more and 0.60 mass % or less Al,
   0 mass % or more and 0.80 mass % or less Ga,
   0 mass % or more and 3.50 mass % or less Co,
   0.88 mass % or more and 1.00 mass % or less B,
   0.05 mass % or more and 0.12 mass % or less C,
   0.11 mass % or more and 0.30 mass % or less O,
   0.015 mass % or more and 0.07 mass % or less N, and
   Fe substantially constituting a balance of the R-T-B based permanent magnet,
the rare earth element includes a heavy rare earth element, and
the R-T-B based permanent magnet contains 0.03 mass % or more and 0.20 mass % or less heavy rare earth element.

A method of manufacturing an R-T-B based permanent magnet according to the present disclosure includes
pulverizing an alloy to provide an alloy powder,
compression-molding the alloy powder to provide a green compact,
sintering the green compact to provide a sintered body, and
heat treating the sintered body with a diffusing material containing a heavy rare earth element in contact therewith,
wherein an oxygen content of the alloy powder is controlled before the alloy powder is compression-molded.

### BRIEF DESCRIPTION OF THE DRAWING(S)

FIG. 1 is a schematic view of an R-T-B based permanent magnet according to the present embodiment.

FIG. 2 is a SEM image of a cross-section of a sintered body of Sample No. 4 before grain boundary diffusion.

FIG. 3 is a SEM image of the cross-section of the sintered body of Sample No. 4 before grain boundary diffusion.

FIG. 4 is a SEM image of a cross-section of a sintered body of Sample No. 63 before grain boundary diffusion.

FIG. 5 is a SEM image of a cross-section of a sintered body of Sample No. 41 before grain boundary diffusion.

FIG. 6 is a SEM image of the cross-section of the sintered body of Sample No. 41 before grain boundary diffusion.

FIG. 7 is a binarized image of FIG. 2.

FIG. 8 is a binarized image of FIG. 4.

### DETAILED DESCRIPTION

It is an object of the present disclosure to provide an R-T-B based permanent magnet having excellent magnetic properties despite having a low heavy rare earth element content and a method of manufacturing the same.

The R-T-B based permanent magnet may have a remanent magnetic flux density Br of 1400 mT or more and a coercivity HcJ of 1900 kA/m or more.

The R-T-B based permanent magnet may include main phases and triple junctions surrounded by three or more of the main phases; the triple junctions may include rare earth oxide phases and low-melting-point grain boundary phases; and the low-melting-point grain boundary phases may have an average circle equivalent diameter of 0.40 μm or more and 1.00 μm or less.

The low-melting-point grain boundary phases may occupy a total area ratio of 1.5% or more and 7.5% or less.

In the method of manufacturing an R-T-B based permanent magnet, the alloy may be coarsely pulverized using hydrogen storage pulverization to provide a coarse powder, and the coarse powder may be finely pulverized to provide the alloy powder.

The coarse powder may be finely pulverized using a jet mill.

The coarse powder may be heat treated in an atmosphere having an oxygen concentration of 0.5% or more and 23% or less to control the oxygen content of the alloy powder.

The coarse powder may be finely pulverized using the jet mill with an inside atmosphere having an oxygen concentration of 0.01% or more and 0.30% or less to control the oxygen content of the alloy powder.

The coarse powder may be finely pulverized using the jet mill with an inside atmosphere containing a mixed gas of a noble gas and an oxygen gas to control the oxygen content of the alloy powder.

The coarse powder may be heat treated in an atmosphere having an oxygen concentration of 0.5% or more and 23% or less, and finely pulverized using the jet mill with an inside atmosphere containing a mixed gas of a noble gas and an oxygen gas or containing a noble gas, to control the oxygen content of the alloy powder.

The method may include performing a first aging treatment for the sintered body before and/or after heat treating the sintered body with the diffusing material containing the heavy rare earth element in contact therewith.

The method may include performing the first aging treatment before heat treating the sintered body with the diffusing material containing the heavy rare earth element in contact therewith.

The first aging treatment may be performed at an aging treatment temperature of 850° C. or more and 950° C. or less for an aging treatment time of 1.5 hours or more and 10 hours or less.

The method may further include performing a second aging treatment for the sintered body after the first aging treatment.

The method may include performing the second aging treatment after heat treating the sintered body with the diffusing material containing the heavy rare earth element in contact therewith.

Hereinafter, the present disclosure is described with reference to an embodiment shown in the drawings.

### <R-T-B Based Permanent Magnet>

An R-T-B based permanent magnet according to the present embodiment includes main phase grains including crystal grains having an R₂T₁₄B type crystal structure. The R-T-B based permanent magnet further includes grain boundaries, each of which is in between two or more of the main phase grains adjacent to each other. In particular, a linear grain boundary between two adjacent main phase grains is referred to as an intergrain interface, and a grain boundary between three or more main phase grains is referred to as a triple junction. The triple junction is, for example, point-like.

In the R-T-B based permanent magnet and the R₂T₁₄B type crystal structure, “R” represents at least one rare earth element, “T” represents at least one transition metal element, and “B” represents boron.

At least one rare earth element contained as “R” in the R-T-B based permanent magnet and the R₂T₁₄B type crystal structure may include Sc, Y, and lanthanoid or may include Y and lanthanoid. At least one transition metal element contained as “T” does not include rare earth elements. The at least one transition metal element contained as “T” may include an iron group element. Boron contained as “B” may be partly substituted with carbon.

The R-T-B based permanent magnet according to the present embodiment may have any shape.

By containing specific elements within specific content ranges, the R-T-B based permanent magnet according to the present embodiment can have improved magnetic properties, particularly improved remanent magnetic flux density Br, improved coercivity HcJ, and an improved squareness ratio Hk/HcJ. The above magnetic properties are those at room temperature (23±1° C.).

Specifically, Br may be 1400 mT or higher, and coercivity HcJ may be 1900 kA/m or higher. Hk/HcJ may be 93.0% or more.

The R-T-B based permanent magnet according to the present embodiment may have a concentration distribution of at least one heavy rare earth element decreasing inward from an outer side of the R-T-B based permanent magnet. The at least one heavy rare earth element may include any heavy rare earth element or elements. The at least one heavy rare earth element may include, for example, Dy or Tb, or Tb.

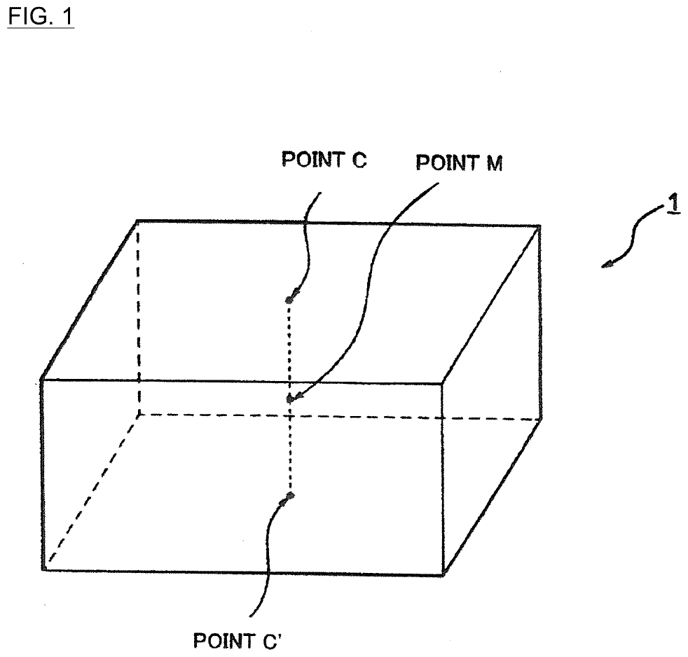

Specifically, as shown in FIG. 1, the R-T-B based permanent magnet 1 according to the present embodiment having a rectangular parallelepiped shape includes surface portions and a center portion; and the surface portions may have a heavy rare earth element content higher than that of the center portion by 2% or more, 5% or more, or 10% or more based on mass. The surface portions mean surfaces of the R-T-B based permanent magnet 1. The surface portions include, for example, POINT C and POINT C′ shown in FIG. 1 (centroids of surfaces facing each other in FIG. 1). The center portion means a center of the R-T-B based permanent magnet 1. The center portion is, for example, at half the thickness of the R-T-B based permanent magnet 1. The center portion is, for example, POINT M shown in FIG. 1 (a midpoint between POINT C and POINT C′). POINT C and POINT C′ in FIG. 1 may be a centroid of a surface having a largest area among surfaces of the R-T-B based permanent magnet 1 and a centroid of a surface facing the former surface, respectively.

In general, rare earth elements are classified into light rare earth elements and heavy rare earth elements. In the R-T-B based permanent magnet according to the present embodiment, light rare earth elements include Sc, Y, La, Ce, Pr, Nd, Sm, and Eu whereas heavy rare earth elements include Gd, Tb, Dy, Ho, Er, Tm, Yb, and Lu.

Any method of providing the R-T-B based permanent magnet according to the present embodiment with the above heavy rare earth element concentration distribution may be used. The R-T-B based permanent magnet can be provided with the heavy rare earth element concentration distribution using, for example, grain boundary diffusion (described later) of the at least one heavy rare earth element.

The main phase grains of the R-T-B based permanent magnet according to the present embodiment may be core-shell grains each including a core and a shell covering the core. In at least the shell, the at least one heavy rare earth element; Dy or Tb; or Tb may be present.

Presence of the at least one heavy rare earth element in the shell can efficiently improve magnetic properties of the R-T-B based permanent magnet.

In the present embodiment, the shell is defined as a portion where the ratio of heavy rare earth elements to light rare earth elements (heavy rare earth elements/light rare earth elements (molar ratio)) is at least twice the ratio at a center portion of the main phase grain. The ratio at the center portion of the main phase grain may be, for example, the ratio at a portion located at a depth that is at least 30% of the grain size from a surface of the main phase grain.

The shell may have any thickness. The thickness may average 500 nm or less. The main phase grains may have any grain size. The grain size may average 1.0 μm or more and 6.5 μm or less. To calculate these averages, a cross-section of the R-T-B based permanent magnet may be observed with a scanning electron microscope (SEM). A field of view having a size including at least fifty core-shell grains may be determined. Thicknesses of the shells of all the core-shell grains in the field of view may be measured and averaged. Grain sizes of all the main phase grains in the field of view may be measured and averaged. The field of view may measure, for example, 100 μm×100 μm.

Any method of making the main phase grains become the above core-shell grains may be used. Such methods include, for example, a method using grain boundary diffusion described later. As the at least one heavy rare earth element diffuses to the grain boundaries and substitutes for the at least one rare earth element at surfaces of the main phase grains, the shells with a high heavy rare earth element content are formed. The main phase grains thus become the core-shell grains.

The R-T-B based permanent magnet according to the present embodiment may contain at least one selected from the group consisting of Nd and Pr as a light rare earth element and at least one selected from the group consisting of Dy and Tb as a heavy rare earth element. The R-T-B based permanent magnet according to the present embodiment preferably contains at least Nd and Tb.

Out of 100 mass % of the entire mass of the R-T-B based permanent magnet according to the present embodiment, the total rare earth element content excluding Nd, Pr, Dy, and Tb may be 0.3 mass % or less, or the total rare earth element content excluding Nd, Pr, and Tb may be 0.3 mass % or less.

Out of 100 mass % of the entire mass of the R-T-B based permanent magnet according to the present embodiment, the R-T-B based permanent magnet has a total rare earth element content (TRE) of 28.50 mass % or more and 32.00 mass % or less. A low TRE easily decreases HcJ and Hk/HcJ. A high TRE easily decreases Hk/HcJ.

The R-T-B based permanent magnet according to the present embodiment may have any total light rare earth element content. Out of 100 mass % of the entire mass of the R-T-B based permanent magnet, the R-T-B based permanent magnet may have a total light rare earth element content of 28.30 mass % or more and 31.97 mass % or less.

In a situation where the R-T-B based permanent magnet contains at least one selected from the group consisting of Nd and Pr, the R-T-B based permanent magnet may have a Pr content of 0.0 mass % or more and 10.0 mass % or less, 0.0 mass % or more and 8.5 mass % or less, or 0.0 mass % or more and 7.6 mass % or less.

Based on mass, the Pr content divided by the total of the Nd content and the Pr content may be 0 or more and 0.35 or less.

Out of 100 mass % of the entire mass of the R-T-B based permanent magnet according to the present embodiment, the R-T-B based permanent magnet has a total heavy rare earth element content (TRH) of 0.03 mass % or more and 0.20 mass % or less. Too low a heavy rare earth element content makes it difficult for HcJ to increase compared to a situation where the R-T-B based permanent magnet contains no heavy rare earth element. Too high a heavy rare earth element content increases raw material costs and further easily decreases Br and Hk/HcJ.

The Fe content of the R-T-B based permanent magnet is substantially the balance of the R-T-B based permanent magnet. That the “Fe content of the R-T-B based permanent magnet is substantially the balance of the R-T-B based permanent magnet” means that the balance of the R-T-B based permanent magnet excluding rare earth elements described earlier and B, Zr, Cu, Al, Ga, Co, C, O, and N described later is substantially only Fe.

In a situation where the Fe content is substantially the balance of the R-T-B based permanent magnet, elements other than rare earth elements, Fe, B, Zr, Cu, Al, Ga, Co, C, O, and N do not significantly affect magnetic properties or the like of the R-T-B based permanent magnet.

Out of 100 mass % of the entire mass of the R-T-B based permanent magnet, for example, the content of each element other than rare earth elements, Fe, B, Zr, Cu, Al, Ga, Co, C, O, and N may be 0.10 mass % or less, or their total may be 1.0 mass % or less. In a situation where the content of each element other than rare earth elements, Fe, B, Zr, Cu, Al, Ga, Co, C, O, and Nis 0.10 mass % or less and their total is 1.0 mass % or less, the Fe content is substantially the balance of the R-T-B based permanent magnet.

Out of 100 mass % of the entire mass of the R-T-B based permanent magnet according to the present embodiment, the R-T-B based permanent magnet has a B content of 0.88 mass % or more and 1.00 mass % or less. The B content may be 0.90 mass % or more and 1.00 mass % or less or may be 0.92 mass % or more and 1.00 mass % or less. A low B content easily decreases Hk/HcJ. A high B content easily decreases HcJ.

The R-T-B based permanent magnet according to the present embodiment further contains Zr. Out of 100 mass % of the entire mass of the R-T-B based permanent magnet, the R-T-B based permanent magnet has a Zr content of 0.01 mass % or more and 0.50 mass % or less. The Zr content may be 0.04 mass % or more and 0.50 mass % or less or may be 0.05 mass % or more and 0.50 mass % or less. Not containing Zr easily decreases HcJ and Hk/HcJ. A high Zr content easily decreases Br.

The R-T-B based permanent magnet according to the present embodiment further contains Cu. Out of 100 mass % of the entire mass of the R-T-B based permanent magnet, the R-T-B based permanent magnet has a Cu content of 0.04 mass % or more and 0.50 mass % or less. The Cu content may be 0.08 mass % or more and 0.50 mass % or less or may be 0.08 mass % or more and 0.30 mass % or less. A low Cu content easily decreases HcJ. A high Cu content easily decreases Br. A high or low Cu content easily decreases Hk/HcJ.

The R-T-B based permanent magnet according to the present embodiment may further contain Al. Out of 100 mass % of the entire mass of the R-T-B based permanent magnet, the R-T-B based permanent magnet has an Al content of 0 mass % or more and 0.60 mass % or less. The Al content may be 0 mass % or more and 0.40 mass % or less. Although the R-T-B based permanent magnet may contain no Al, the lower the Al content, the lower the HcJ tends to be. A high Al content easily decreases Br.

The R-T-B based permanent magnet according to the present embodiment may further contain Ga. Out of 100 mass % of the entire mass of the R-T-B based permanent magnet, the R-T-B based permanent magnet has a Ga content of 0 mass % or more and 0.80 mass % or less. The Ga content may be 0.05 mass % or more and 0.70 mass % or less. Although the R-T-B based permanent magnet may contain no Ga, the lower the Ga content, the lower the HcJ tends to be. A high Ga content easily decreases Br.

The R-T-B based permanent magnet according to the present embodiment may further contain Co. Out of 100 mass % of the entire mass of the R-T-B based permanent magnet, the R-T-B based permanent magnet has a Co content of 0 mass % or more and 3.50 mass % or less. The Co content may be 0.2 mass % or more and 3.20 mass % or less or may be 0.3 mass % or more and 3.20 mass % or less. Although the R-T-B based permanent magnet may contain no Co, the lower the Co content, the lower the corrosion resistance tends to be. A high Co content increases costs.

The R-T-B based permanent magnet according to the present embodiment further contains C. Out of 100 mass % of the entire mass of the R-T-B based permanent magnet, the R-T-B based permanent magnet has a C content of 0.05 mass % or more and 0.12 mass % or less. The C content may be 0.05 mass % or more and 0.11 mass % or less. A low C content easily decreases HcJ. A high C content easily decreases HcJ and Hk/HcJ.

The R-T-B based permanent magnet according to the present embodiment further contains O. Out of 100 mass % of the entire mass of the R-T-B based permanent magnet, the R-T-B based permanent magnet has an O content of 0.11 mass % or more and 0.30 mass % or less. The O content may be 0.13 mass % or more and 0.29 mass % or less or may be 0.13 mass % or more and 0.26 mass % or less. A low O content easily decreases HcJ. A high O content easily decreases Br and HcJ.

The R-T-B based permanent magnet according to the present embodiment further contains N. Out of 100 mass % of the entire mass of the R-T-B based permanent magnet, the R-T-B based permanent magnet has a N content of 0.015 mass % or more and 0.07 mass % or less. The N content may be 0.02 mass % or more and 0.07 mass % or less. Too high or too low a N content easily decreases HcJ.

Conventionally and generally known methods of measuring various components contained in the R-T-B based permanent magnet according to the present embodiment can be used. The content of various elements is measured using, for example, an X-ray fluorescence analysis or an inductively coupled plasma emission spectroscopic analysis (ICP-AES). The O content is measured using, for example, an inert gas fusion infrared absorption method. The C content is measured using, for example, an infrared absorption method after combustion. The N content is measured using, for example, a thermal conductimetric method after fusion in a current of inert gas.

The R-T-B based permanent magnet according to the present embodiment may have any shape. Examples of such shapes include a rectangular parallelepiped shape and a C shape.

Described below in detail is a method of manufacturing an R-T-B based sintered magnet as an example method of manufacturing the R-T-B based permanent magnet according to the present embodiment. However, methods of manufacturing the R-T-B based permanent magnet are not limited to this method. Other known methods may be used.

### [Raw Material Powder Preparation Step]

A raw material powder can be prepared using a known method. The following description is provided on the premise that a one-alloy method, in which a single alloy is used, is employed in the present embodiment; however, a so-called two-alloy method, in which two or more alloys having different compositions are mixed to prepare a raw material powder, may be employed.

First, a raw material alloy of the R-T-B based permanent magnet is prepared (alloy preparation step). In the alloy preparation step, raw material metals corresponding to the composition of the R-T-B based permanent magnet according to the present embodiment are melted using a known method and are then cast to provide the raw material alloy having a desired composition.

Examples of the raw material metals can include simple substances of rare earth elements, simple substances of metal elements (e.g., Fe), or compounds containing multiple elements (e.g., ferroboron), as appropriate. Any casting method of casting the raw material alloy from the raw material metals may be used. For the R-T-B based permanent magnet to have high magnetic properties, a strip casting method may be used. The resultant raw material alloy may undergo a homogenization treatment using a known method as necessary.

After the raw material alloy is prepared, it is pulverized (pulverization step). In terms of attaining high magnetic properties, an atmosphere of each step from the pulverization step to a sintering step can have a low oxygen concentration. The oxygen concentration of the atmosphere of each step may be, for example, 200 ppm or less (0.02% or less). However, in any of the steps before a fine powder is pressed into an intended shape, the oxygen concentration of the atmosphere may be increased to control the O content of an alloy powder. Details are provided later.

Described below is a two-step process of the pulverization step, which includes a coarse pulverization step of pulverizing the raw material alloy to a particle size of about several hundred μm to about several mm and a fine pulverization step of finely pulverizing a coarse powder to a particle size of about several μm. However, a one-step process consisting solely of the fine pulverization step may be carried out.

In the coarse pulverization step, the raw material alloy is coarsely pulverized until it has a particle size of about several hundred μm to about several mm. This provides the coarse powder. Any coarse pulverization method may be used. Known methods, such as a method involving hydrogen storage pulverization, can be used.

In hydrogen storage pulverization, the alloy stores hydrogen (hydrogen storage) and is then dehydrogenated for pulverization (hydrogen pulverization). The coarse powder resulting from hydrogen pulverization is heat treated in an atmosphere with an oxygen concentration of 0.5% or more and 23% or less. This can control the O content of the alloy powder eventually obtained. Along with the control of the O content, the N content may also be controlled. The heat treatment temperature may be 50° C. or more and 200° C. or less. The heat treatment time may be 5 minutes or more and 4 hours or less. For heat treating the coarse powder, an agitating apparatus including a screw or the like may be used.

Then, the coarse powder is finely pulverized until it has an average particle size of about several μm (fine pulverization step). This provides a fine powder (raw material powder). The average particle size of the fine powder may be 1 μm or more and 10 μm or less, 2 μm or more and 6 μm or less, or 2 μm or more and 4 μm or less.

Any fine pulverization method may be used. Fine pulverization is carried out using, for example, a method involving a jet mill.

An oxygen concentration of 0.01% or more and 0.30% or less of the atmosphere of fine pulverization can control the O content of the alloy powder eventually obtained. The oxygen concentration of the atmosphere of fine pulverization may be 0.02% or more and 0.30% or less or may be 0.03% or more and 0.30% or less. Along with the control of the O content, the N content may also be controlled.

For controlling the O content of the alloy powder eventually obtained, an oxygen gas or a mixed gas including a noble gas and an oxygen gas is preferably supplied as appropriate so that the oxygen concentration of the atmosphere of fine pulverization does not fall below the lower limit of the above numerical range of the oxygen concentration. Despite the oxygen concentration of the atmosphere at the time of starting fine pulverization not falling below the lower limit of the above numerical range of the oxygen concentration, insufficient supply of oxygen to the atmosphere of fine pulverization decreases the oxygen concentration of the atmosphere. This is because the powder being finely pulverized absorbs oxygen.

Using a mixed gas atmosphere including a noble gas and an oxygen gas as an inside atmosphere of the jet mill for fine pulverization can control the O content of the alloy powder eventually obtained. Along with the control of the O content, the N content may also be controlled. The noble gas may be of any type. Examples of noble gases include an Ar gas, a He gas, and a mixed gas including an Ar gas and a He gas.

Adding various pulverization aids (e.g., lauramide and oleamide) to the coarse powder for fine pulverization can provide the fine powder such that crystal grains are easily oriented in a specific direction when pressed with pressure in a magnetic field. Changing the amount of the pulverization aids added can control the C content and the N content of the R-T-B based permanent magnet.

As for control of the O content, for example, heat treating the coarse powder in an atmosphere with an oxygen concentration of 0.5% or more and 23% or less as described above and using a noble gas or a mixed gas including a noble gas and an oxygen gas as an inside atmosphere of the jet mill for fine pulverization can control the O content of the alloy powder eventually obtained. Along with the control of the O content, the N content may also be controlled. The noble gas may be of any type. Examples of noble gases include an Ar gas, a He gas, and a mixed gas including an Ar gas and a He gas.

### [Pressing Step]

In a pressing step (compression-molding step), the above fine powder is pressed into an intended shape. Any pressing method may be used. According to the present embodiment, a mold is filled with the fine powder, and pressure is applied thereto in a magnetic field. Because crystal grains of a resultant green compact are oriented in a specific direction, the R-T-B based permanent magnet can have higher Br.

The pressure applied during pressing can be 20 MPa or more and 300 MPa or less. The magnetic field applied can be 950 kA/m or more or can be 950 kA/m or more and 1600 kA/m or less. The magnetic field applied is not limited to a static magnetic field and can be a pulsed magnetic field. Alternatively, a static magnetic field and a pulsed magnetic field can be used together.

As for pressing methods, other than dry pressing, in which the fine powder is directly pressed as described above, wet pressing can be used, in which slurry including a solvent (e.g., oil) and the fine powder dispersed therein is pressed.

The green compact resulting from pressing the fine powder may have any shape. The green compact at this time can have a density of 4.0 Mg/m³ to 4.3 Mg/m³.

### [Sintering Step]

A sintering step is a step of sintering the green compact in a vacuum or an inert gas atmosphere to provide a sintered body. Sintering conditions need to be controlled according to conditions, such as a composition, a pulverization method, and a difference in particle size and particle size distribution. The green compact is sintered through, for example, a heat treatment in a vacuum or an inert gas atmosphere at 1000° C. or more and 1200° C. or less for 1 hour or more and 20 hours or less. Sintering under the above sintering conditions provides the sintered body with high density. In the present embodiment, the sintered body has a density of at least 7.45 Mg/m³ or more. The density of the sintered body may be 7.50 Mg/m³ or more.

### [Aging Treatment Step]

An aging treatment step is a step of heat treating (aging treatment) the sintered body at a temperature lower than the sintering temperature. Whether to perform the aging treatment is not limited. The number of the aging treatment is also not limited. Described below is the embodiment in which the aging treatment is performed twice. In a situation where the aging treatment is performed only once, this aging treatment step is deemed to be a first aging treatment step described later.

An aging treatment step that is carried out for the first time is referred to as a first aging treatment step. An aging treatment step that is carried out for the second time is referred to as a second aging treatment step. The aging treatment temperature of the first aging treatment step is referred to as T1. The aging treatment temperature of the second aging treatment step is referred to as T2.

A dispersion state (described later) of the triple junctions of the R-T-B based permanent magnet according to the present embodiment changes depending on conditions of the first aging treatment step. The atmosphere of the first aging treatment step is not limited. The atmosphere may be, for example, an argon atmosphere, a vacuum atmosphere, or a decompressed argon atmosphere where argon flows in a vacuum. T1 is not limited. T1 may be 700° C. or more and 1000° C. or less, 700° C. or more and 950° C. or less, or 850° C. or more and 950° C. or less. The aging treatment time of the first aging treatment step is not limited. The aging treatment time of the first aging treatment step may be 1.0 hour or more and 15 hours or less, 1.0 hour or more and 10 hours or less, or 1.5 hours or more and 10 hours or less.

The R-T-B based permanent magnet according to the present embodiment has a composition within the predetermined range, particularly a carbon content, an oxygen content, and a nitrogen content within the predetermined ranges. Carrying out the first aging treatment step for such an R-T-B based permanent magnet under the conditions within the above ranges suitably controls the composition of liquid phases in the triple junctions during the first aging treatment step. The liquid phases thereby have suitable viscosity. Consequently, a network connecting the triple junctions is formed. Through this network, the liquid phases are supplied to the intergrain interfaces from the triple junctions. While the volume ratio of the main phases is maintained, the triple junctions become suitably dispersed, and the intergrain interfaces thicken. Consequently, magnetic properties easily improve.

The first aging treatment step may be carried out before or after a grain boundary diffusion step (described later). Carrying out the first aging treatment step before the grain boundary diffusion step (described later) easily and suitably controls circle equivalent diameters of low-melting-point grain boundary phases and their total area ratio. The first aging treatment step may double as a heat treatment in the grain boundary diffusion step (described later).

T2 and the aging treatment time of the second aging treatment step are not limited. T2 can be 450° C. or more and 700° C. or less. The aging treatment time can be 1 hour or more and 10 hours or less.

The second aging treatment step may be carried out after the first aging treatment step and before the grain boundary diffusion step (described later). The second aging treatment step may be carried out after the grain boundary diffusion step (described later).

### [Machining Step (Before Grain Boundary Diffusion)]

As necessary, a step of machining the sintered body according to the present embodiment into a desired shape may be employed. Examples of machining methods include shape machining (e.g., cutting and grinding) and chamfering (e.g., barrel polishing).

### [Grain Boundary Diffusion Step]

The grain boundary diffusion step can be carried out through adhesion of a diffusing material to at least one surface of the sintered body and heating of the sintered body having the diffusing material adhered. This provides the R-T-B based permanent magnet.

### (Diffusing Material Adhesion Step)

In the present embodiment, the diffusing material may be of any type. The diffusing material may contain a hydride of a heavy rare earth element (e.g., Tb), may contain a heavy rare earth element and Cu, or may contain a simple substance of a heavy rare earth element (e.g., Tb metal).

The diffusing material may be slurry including a solvent in addition to the above hydride of the heavy rare earth element or the like. The solvent included in the slurry may be a solvent other than water. The solvent may be, for example, an organic solvent (e.g., alcohol, aldehyde, and ketone). The diffusing material may further include a binder. The binder may be of any type. As the binder, for example, resin (e.g., acrylic resin) may be included. Inclusion of the binder makes the diffusing material easily adhere to the at least one surface of the sintered body.

The diffusing material may be a paste including a solvent and a binder in addition to the above hydride of the heavy rare earth element or the like. The paste has fluidity and high viscosity. The viscosity of the paste is higher than the viscosity of the slurry.

Before a diffusion treatment (described later), drying for removing the solvent from the sintered body having the slurry or the paste adhered and removal of the binder may be carried out.

The holding temperature during drying may be 200° C. or less. The holding time during drying may be 3 minutes or more and 1 hour or less.

The holding temperature during binder removal may be 200° C. or more and 800° C. or less. The holding time during binder removal may be 10 minutes or more and 10 hours or less. In a situation where, in particular, the holding temperature during binder removal is high, grain boundary diffusion of the heavy rare earth element may proceed during binder removal. The binder removal atmosphere is an inert gas atmosphere. Removal of the binder from the sintered body having the slurry or the paste adhered can prevent or mitigate formation of a carbide of the heavy rare earth element at the at least one surface of the magnet base material, enabling a further decrease in heavy rare earth element usage.

Alternatively, sputtering with a simple substance of a heavy rare earth element (e.g., Tb metal) as a target may be used for adhesion of the simple substance of the heavy rare earth element as the diffusion material to the at least one surface of the sintered body. Any sputtering apparatus may be used. Magnetron sputtering may be used. In a situation where, in particular, the amount of adhesion of the diffusion material is small, preferred is the method of adhesion of the diffusing material using sputtering.

### (Heating Step)

In a heating step of the grain boundary diffusion step, along with an increase in temperature, grain boundary phases with a high rare earth element concentration (in particular, the low-melting-point grain boundary phases) present in the grain boundaries of the magnet base material (sintered body) become the liquid phases, into which the diffusing material dissolves. This diffuses a component of the diffusing material from the at least one surface of the magnet base material to the inside of the magnet base material. In a situation where sputtering is used for adhesion of the diffusing material (e.g., simple substance of the heavy rare earth element) to the at least one surface of the sintered body, a substrate on which the sintered body is placed may be heated to diffuse the component of the diffusing material.

The diffusion treatment of the grain boundary diffusion step according to the present embodiment may be performed continuously from the above binder removal. Alternatively, the sintered body may once be cooled to room temperature after the binder removal and may then be heated again. The holding temperature of the diffusion treatment may be 700° C. or more and 1000° C. or less. In the grain boundary diffusion step, the temperature of the magnet base material may be gradually increased from a temperature lower than the diffusion treatment temperature to reach the diffusion treatment temperature.

The time during which the temperature of the base material is maintained at the diffusion treatment temperature (diffusion treatment time) may be, for example, 1 hour or more and 50 hours or less. The atmosphere around the base material in the diffusion treatment may be a non-oxidizing atmosphere. The non-oxidizing atmosphere may be, for example, a noble gas (e.g., argon). The pressure of the atmosphere around the magnet base material in the diffusion treatment may be 1 kPa or less. In a situation where the diffusing material is the hydride of the heavy rare earth element, such a decompressed atmosphere facilitates dehydrogenation of the hydride. Consequently, the diffusing material easily dissolves into the liquid phases.

After the grain boundary diffusion step, the above second aging treatment step may be carried out. Moreover, the first aging treatment step may be carried out before the grain boundary diffusion step. Carrying out the first aging treatment step before the grain boundary diffusion step and carrying out the second aging treatment step after the grain boundary diffusion step make it easier to suitably control the circle equivalent diameters and the total area ratio of the low-melting-point grain boundary phases. This easily improves magnetic properties of the R-T-B based sintered magnet eventually obtained.

[Machining Step (after Grain Boundary Diffusion)]

After the grain boundary diffusion step, polishing may be carried out to remove the diffusing material remaining on the at least one surface of the R-T-B based permanent magnet. The R-T-B based permanent magnet may also undergo other machining. Machining such as shape machining (e.g., cutting and grinding) or surface machining (e.g., chamfering, such as barrel polishing) may be carried out. Polishing may be carried out before the second aging treatment step or after the second aging treatment step.

In the present embodiment, the machining steps are carried out before and after grain boundary diffusion; however, these steps do not necessarily have to be carried out.

In particular, the R-T-B based permanent magnet after grain boundary diffusion easily has the concentration distribution of the at least one heavy rare earth element decreasing inward from the outer side of the R-T-B based permanent magnet. The main phase grains included in the R-T-B based permanent magnet after grain boundary diffusion easily have the above core-shell structure.

The R-T-B based permanent magnet according to the present embodiment obtained in such a manner has desired properties despite having a relatively low heavy rare earth element content. Specifically, Br, HcJ, and Hk/HcJ are high.

Magnetizing the R-T-B based permanent magnet according to the present embodiment obtained using the above method provides the magnetic R-T-B based permanent magnet.

Described below is a reason why the R-T-B based permanent magnet according to the present embodiment has desired properties despite having a relatively low heavy rare earth element content.

In the sintered body having a composition within the above range, particularly a carbon content, an oxygen content, and a nitrogen content within the above ranges, before grain boundary diffusion, the intergrain interfaces easily thicken (hereinafter, the sintered body before grain boundary diffusion may be referred to as base material).

In the base material prepared using the above manufacturing method to mainly control the oxygen content, the intergrain interfaces easily thicken.

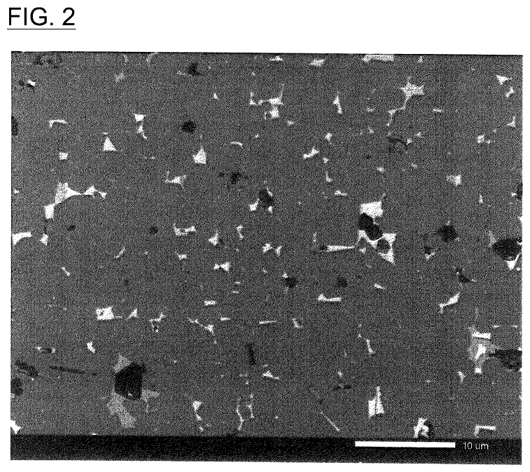

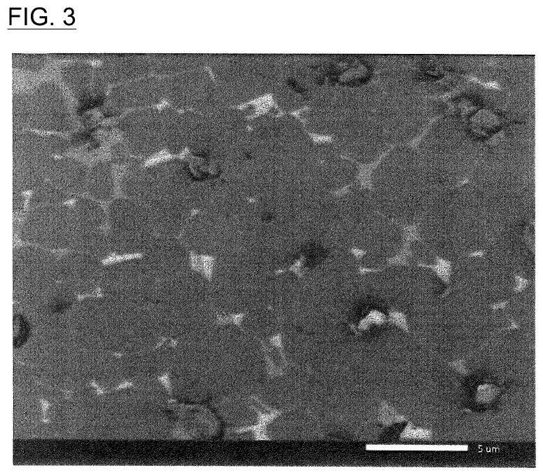

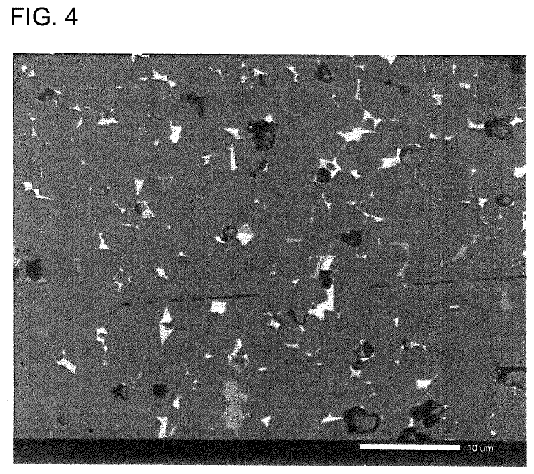

Specifically, the intergrain interfaces of the base material, which is a precursor of the R-T-B based permanent magnet according to the present embodiment, are thick to the extent that the intergrain interfaces can be identified in an image (SEM image) capturing a cross-section using a SEM as shown in FIGS. 2 to 4. FIG. 2 is a SEM image of a base material of Sample No. 4 (Example described later) at a magnification of ×2500. FIG. 3 is a SEM image of the base material of Sample No. 4 (Example described later) at a magnification of ×5000. FIG. 4 is a SEM image of a base material of Sample No. 63 (Example described later) at a magnification of ×2500. All the SEM images of the present embodiment are backscattered electron images.

Such thickness of the intergrain interfaces of the base material to the extent that the intergrain interfaces can be identified increases HcJ of the base material. Despite a small amount of diffusion of the heavy rare earth element, magnetic properties of the R-T-B based permanent magnet resulting through grain boundary diffusion improve.

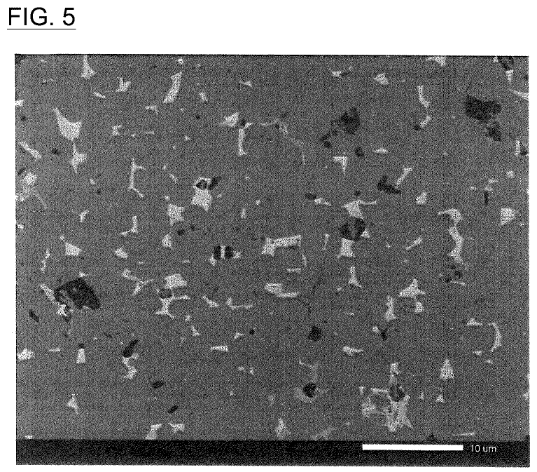

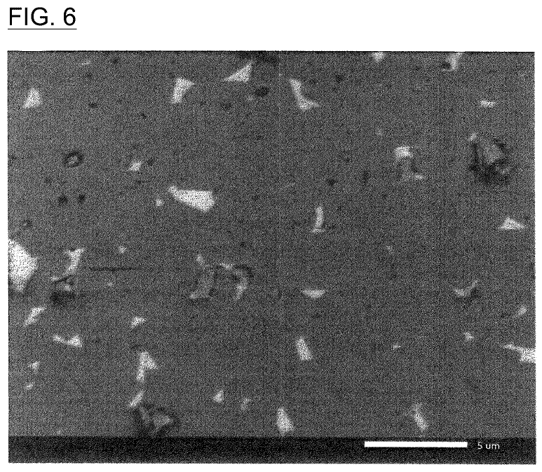

FIG. 5 is a SEM image of a base material of Sample No. 41 (Comparative Example described later) at a magnification of ×2500. FIG. 6 is a SEM image of the base material of Sample No. 41 (Comparative Example described later) at a magnification of ×5000. In neither of these images, intergrain interfaces can be identified. In such a situation, the thickness of the intergrain interfaces can be checked using a transmission electron microscope (TEM). The actually checked thickness of the intergrain interfaces is about 5 nm.

The intergrain interfaces whose presence can be confirmed in a SEM image have a thickness of about 15 nm or more. The thickness of the intergrain interfaces may be 15 nm or more and 50 nm or less. The intergrain interfaces of the sintered body may be deemed sufficiently thick when at least five intergrain interfaces with a length of 0.5 μm or more are observed in a freely selected region measuring 20 μm×15 μm in a field of view of a sufficiently large SEM image observed at a magnification of ×5000.

Moreover, having a composition within the above range, particularly a carbon content, an oxygen content, and a nitrogen content within the above ranges, and undergoing the predetermined heat treatment under the conditions within the above ranges (in particular, the predetermined first aging treatment) enable the R-T-B based permanent magnet according to the present embodiment to have the triple junctions in a suitably dispersed state. This makes it easier to thicken the intergrain interfaces while the volume ratio of the main phases is maintained. It is thus assumed that, consequently, the magnetic properties easily improve.

To evaluate the dispersion state of the triple junctions, rare earth oxide phases and the low-melting-point grain boundary phases are extracted from all triple junctions included in a field of view of a SEM image. The low-melting-point grain boundary phases are grain boundary phases other than the rare earth oxide phases with a relatively high melting point.

The rare earth oxide phases may contain nitrogen and/or carbon in addition to at least one rare earth element and oxygen. The composition of the rare earth oxide phases is not limited. The rare earth oxide phases may have a rare earth element content of, for example, 30 to 70 at %. The rare earth oxide phases may have an oxygen content of 10 to 60 at %. The rare earth oxide phases may have a carbon content of 0 to 40 at %. The rare earth oxide phases may have a nitrogen content of 0 to 30 at %. The rare earth oxide phases may mainly contain the at least one rare earth element, oxygen, carbon, and nitrogen. That the rare earth oxide phases “mainly contain the at least one rare earth element, oxygen, carbon, and nitrogen” means that the content of elements other than the at least one rare earth element, oxygen, carbon, and nitrogen is 0 at % or more and 20 at % or less in total.

Dividing the total area of the low-melting-point grain boundary phases included in one cross-section of the R-T-B based permanent magnet, i.e., the total area of the grain boundary phases other than the rare earth oxide phases, by the area of that cross-section can calculate the total area ratio of the low-melting-point grain boundary phases in the R-T-B based permanent magnet. The area of that cross-section is calculated using the magnification of a SEM image and the number of pixels in the SEM image.

Calculating the circle equivalent diameters of the low-melting-point grain boundary phases included in one cross-section of the R-T-B based permanent magnet and finding their arithmetic mean can calculate the average circle equivalent diameter of the low-melting-point grain boundary phases. The circle equivalent diameters of the low-melting-point grain boundary phases are parameters resulting from conversion into diameters of circles having the same areas as those of the low-melting-point grain boundary phases.

These parameters can be used to evaluate the dispersion state of the triple junctions.

A reason why the total area of the rare earth oxide phases and circle equivalent diameters of the rare earth oxide phases are not taken into account is assumed to be because it is difficult for the rare earth oxide phases to contribute to dispersion of the triple junctions. A reason why it is assumed that the rare earth oxide phases are difficult to contribute to dispersion of the triple junctions is because the rare earth oxide phases have a high melting point and are difficult to become liquid phases to flow via the above first aging treatment or the heat treatment for grain boundary diffusion.

Methods of distinguishing between the low-melting-point grain boundary phases (grain boundary phases other than the rare earth oxide phases) and portions other than the low-melting-point grain boundary phases (the main phases and the rare earth oxide phases) are not limited. For example, binarization of a SEM image based on contrast may be performed. Binarization of the SEM image turns the SEM image into black and white (two colors). Image processing software for binarization is not limited. Image processing software that enables the shapes of the low-melting-point grain boundary phases to be identified after binarization is used.

A binarization threshold is set between the low-melting-point grain boundary phases and portions other than the low-melting-point grain boundary phases. The threshold may be set automatically using the image processing software or may be set through a visual check of the SEM image. Because the portions other than the low-melting-point grain boundary phases (the main phases and the rare earth oxide phases) and the low-melting-point grain boundary phases are different in image contrast, binarization can clearly distinguish between them.

The total area ratio of the low-melting-point grain boundary phases is not limited. The total area ratio may be 1.5% or more and 7.5% or less or may be 3.5% or more and 6.8% or less. The average circle equivalent diameter of the low-melting-point grain boundary phases is not limited. The average circle equivalent diameter may be 0.40 μm or more and 1.00 μm or less or may be 0.46 μm or more and 0.92 μm or less. When the total area ratio of the low-melting-point grain boundary phases and the average circle equivalent diameter of the low-melting-point grain boundary phases are within the above ranges, the dispersion state of the triple junctions can be said to be good.

The R-T-B based permanent magnet according to the present embodiment is suitably included in a motor, an electric generator, etc.

### EXAMPLES

Hereinafter, the present disclosure is described based on further detailed examples. However, the present disclosure is not limited to these examples.

### (Manufacture of R-T-B Based Permanent Magnet)

A raw material alloy was prepared using a strip casting method so that an R-T-B based permanent magnet eventually obtained had a composition of each sample shown in Tables 1 to 9. Tb was not contained in the raw material alloy and was contained only in a diffusing material paste described later. As other elements not shown in Tables 1 to 9, H, Si, Ca, La, Ce, Cr, or the like may have been detected. Si may have mainly come from a ferroboron raw material and a crucible used at the time of melting the alloy. Ca, La, and Ce may have come from a rare earth raw material. Cr may have come from electrolytic iron. In Tables 1 to 9, “bal.” shown as the Fe content indicates that, out of 100 mass % of the entire R-T-B based permanent magnet containing these other elements, the Fe content was substantially the balance of the R-T-B based permanent magnet.

Then, a hydrogen gas flowed for the raw material alloy at room temperature for 1 hour so that the raw material alloy stored hydrogen. Then, the atmosphere was switched to an Ar gas, and a dehydrogenation treatment was performed at 500° C. for 1 hour for hydrogen storage pulverization of the raw material alloy to provide a coarse powder.

Then, the resultant coarse powder was introduced into an agitating apparatus including a screw. The coarse powder was heat treated while being agitated in an atmosphere with an oxygen concentration of 0.5% or more and 23% or less. The heat treatment temperature was 140° C. The heat treatment time was 2.5 hours. Changing the oxygen concentration of the atmosphere controlled the oxygen concentration of an alloy powder resulting from fine pulverization.

To the coarse powder after the heat treatment, 0.1% oleamide was added as a pulverization aid based on mass, and they were mixed with a Nauta mixer.

The resultant mixture was finely pulverized in a nitrogen stream using an impact plate type jet mill apparatus to provide a fine powder (raw material powder) having an average particle size of about 3.0 μm. The average particle size was an average particle size D50 measured with a laser diffraction type particle size analyzer.

The resultant fine powder was pressed in a magnetic field to provide a green compact. The magnetic field applied at this time was a static magnetic field of 1200 kA/m. The pressure applied during pressing was 120 MPa. The direction of magnetic field application and the direction of pressure application were orthogonal to each other.

Then, the green compact was sintered to provide a sintered body. Optimum sintering conditions differed according to the composition or the like. The green compact was held at a temperature in a range of 1030° C. to 1070° C. for 4 hours. The sintering atmosphere was a vacuum. The sintering density at this time was within a range of 7.51 Mg/m³ to 7.55 Mg/m³. Then, while Ar flowed under atmospheric pressure (1 atm), the sintered body underwent a first aging treatment. The first aging treatment temperature T1 was 900° C. The first aging treatment time was 2 hours. From the above, the sintered body, with which each sample shown in Tables 1 to 9 was obtained through grain boundary diffusion, was prepared.

### (Preparation of Diffusing Material Paste)

Then, the diffusing material paste used for grain boundary diffusion except for Sample Nos. 71a and 72 was prepared.

A hydrogen gas flowed for Tb metal having a purity of 99.9% at room temperature so that Tb metal stored hydrogen. Then, the atmosphere was switched to an Ar gas, and a dehydrogenation treatment was performed at 500° C. for 1 hour for hydrogen storage pulverization of Tb metal. To 100 mass % Tb metal, 0.05 mass % zinc stearate was added as a pulverization aid, and they were mixed with a Nauta mixer. Then, the mixture was finely pulverized using a jet mill in an atmosphere with 3000 ppm oxygen to provide a finely pulverized powder of a Tb hydride having an average particle size of about 10.0 μm.

The finely pulverized powder of the Tb hydride (60 parts by mass), a Cu metal powder (10 parts by mass), alcohol (25 parts by mass), and acrylic resin (5 parts by mass) were kneaded to provide the diffusing material paste. The alcohol was a solvent. The acrylic resin was a binder.

### (Application of Diffusing Material Paste and Heat Treatment)

The above sintered body was machined into a size measuring length 11 mm×width 11 mm×thickness 4.2 mm (thickness in the direction of an axis of easy magnetization was 4.2 mm). Then, an etching treatment was performed, in which the machined sintered body was immersed in a mixed solution including 100 parts by mass ethanol and 3 parts by mass nitric acid for 3 minutes and then in ethanol for 1 minute. This etching treatment, in which the machined sintered body was immersed in the mixed solution for 3 minutes and then in ethanol for 1 minute, was performed twice.

Then, the above diffusing material paste was applied to all surfaces of the sintered body after the etching treatment. The amount of application of the diffusing material paste was determined so that the Tb content of the R-T-B based permanent magnet eventually obtained was as shown in Tables 1 to 9.

In Sample No. 71, machining and etching were carried out, but application of the diffusing material paste was not carried out.

Sample Nos. 71a and 72 are described below.

In Sample Nos. 71a and 72, to the sintered body after the machining and the etching treatment, Tb was adhered using sputtering with Tb metal as a target. For sputtering, magnetron sputtering was used.

The amount of Tb adhered to the sintered body was determined so that the Tb content of the R-T-B based permanent magnet eventually obtained was as shown in Tables 1 to 9.

Then, the sintered body was dried. Specifically, the sintered body with the diffusing material paste applied was left in an oven at 160° C. for 45 minutes in air to remove the solvent included in the diffusing material paste (Sample No. 71, in which the diffusing material paste was not applied to the sintered body, and Sample Nos. 71a and 72, in which Tb was adhered to the sintered body using sputtering, were excluded).

Then, the binder in the sintered body was removed. Specifically, the dried sintered body with the diffusing material paste was left in an oven at 400° C. for 3 hours in an Ar gas atmosphere to remove the remaining binder included in the dried diffusing material (Sample No. 71, in which the diffusing material paste was not applied to the sintered body, and Sample Nos. 71a and 72, in which Tb was adhered to the sintered body using sputtering, were excluded). Then, while Ar flowed under atmospheric pressure (1 atm), the sintered body was heated at 900° C. for 30 hours for grain boundary diffusion of the heavy rare earth element. Further, while Ar flowed under atmospheric pressure (1 atm), the sintered body was heated at 500° C. for 1 hour as a second aging treatment. From the above, the R-T-B based permanent magnet of each sample shown in Tables 1 to 9 was manufactured.

The surfaces of the R-T-B based permanent magnet were scraped off by 0.1 mm each. Then, the composition, microstructure, element distribution, and magnetic properties were evaluated.

The R-T-B based permanent magnet was machined into a size measuring length 11 mm×width 11 mm×thickness 4.2 mm (thickness in the direction of the axis of easy magnetization was 4.2 mm) using a surface grinding machine to evaluate the magnetic properties at room temperature using a BH tracer. The R-T-B based permanent magnet was magnetized with a pulsed magnetic field of 4000 kA/m before the magnetic properties were measured. Because the R-T-B based permanent magnet had a small thickness, three such magnets were stacked to evaluate the magnetic properties. In the present Examples, Hk/HcJ was calculated using Hk/HcJ×100(%), where Hk (kA/m) denoted the magnetic field at the time when magnetization was 90% of Br in the second quadrant of a magnetization J-magnetic field H curve (J-H demagnetization curve).

In the present Examples, Br of the R-T-B based permanent magnet was defined as good at 1400 mT or more or better at 1430 mT or more. HcJ of the R-T-B based permanent magnet was defined as good at 1900 kA/m or more, better at 1915 kA/m or more, or best at 1950 kA/m or more. Hk/HcJ of the R-T-B based permanent magnet was defined as good at 93.0% or more or better at 95.0% or more.

A cross-section of the sintered body (base material) before grain boundary diffusion was observed with a SEM. Observation results were defined as good when at least five intergrain interfaces with a length of 0.5 μm or more were observed in a freely selected region measuring 20 μm×15 μm in a field of view of a sufficiently large SEM image observed at a magnification of ×5000 at an accelerating voltage of 5.0 kV. Observation results were defined as poor when at least five intergrain interfaces with a length of 0.5 μm or more were not observed. Tables 1 to 9 show the results.

TABLE 1

| | | Magnet composition | | | | | | | | |
|---|---|---|---|---|---|---|---|---|---|---|
| | | | | Tb | | | | | | |
| Sample | Example/ | Nd | Pr | (=TRH) | TRE | Fe | B | Zr | Cu | Al |
| No. | Comparative Example | (mass %) | (mass %) | (mass %) | (mass %) | (mass %) | (mass %) | (mass %) | (mass %) | (mass %) |
| 1 | Comparative Example | 22.17 | 5.98 | 0.11 | 28.26 | bal. | 0.92 | 0.05 | 0.30 | 0.16 |
| 2 | Example | 22.39 | 6.03 | 0.11 | 28.53 | bal. | 0.92 | 0.05 | 0.30 | 0.16 |
| 3 | Example | 22.83 | 6.15 | 0.11 | 29.09 | bal. | 0.92 | 0.05 | 0.30 | 0.16 |
| 4 | Example | 24.40 | 6.55 | 0.11 | 31.06 | bal. | 0.92 | 0.05 | 0.30 | 0.16 |
| 5 | Example | 24.73 | 6.60 | 0.11 | 31.44 | bal. | 0.92 | 0.05 | 0.30 | 0.16 |
| 6 | Example | 25.11 | 6.74 | 0.11 | 31.96 | bal. | 0.92 | 0.05 | 0.30 | 0.16 |
| 7 | Comparative Example | 25.32 | 6.79 | 0.11 | 32.22 | bal. | 0.92 | 0.05 | 0.30 | 0.16 |

| | | | | | | Base material | | | |
|---|---|---|---|---|---|---|---|---|---|
| | | | | | | composition | Magnetic properties | | |
| | Magnet composition | | | | | Two-grain | | | Hk/ |
| Sample | Ga | Co | O | C | N | boundary | Br | HcJ | HcJ |
| No. | (mass %) | (mass %) | (mass %) | (mass %) | (mass %) | interface | (mT) | (kA/m) | (%) |
| 1 | 0.60 | 1.00 | 0.14 | 0.08 | 0.06 | Good | 1475 | 1812 | 90.7 |
| 2 | 0.60 | 1.00 | 0.14 | 0.08 | 0.06 | Good | 1471 | 1917 | 94.3 |
| 3 | 0.60 | 1.00 | 0.14 | 0.08 | 0.06 | Good | 1467 | 1976 | 94.9 |
| 4 | 0.60 | 1.00 | 0.14 | 0.08 | 0.06 | Good | 1438 | 2015 | 96.2 |
| 5 | 0.60 | 1.00 | 0.14 | 0.08 | 0.06 | Good | 1433 | 2028 | 95.8 |
| 6 | 0.60 | 1.00 | 0.14 | 0.08 | 0.06 | Good | 1425 | 2040 | 95.4 |
| 7 | 0.60 | 1.00 | 0.14 | 0.08 | 0.06 | Good | 1422 | 2044 | 92.4 |

TABLE 2

| | | Magnet composition | | | | | | | | |
|---|---|---|---|---|---|---|---|---|---|---|
| | | | | Tb | | | | | | |
| Sample | Example/ | Nd | Pr | (=TRH) | TRE | Fe | B | Zr | Cu | Al |
| No. | Comparative Example | (mass %) | (mass %) | (mass %) | (mass %) | (mass %) | (mass %) | (mass %) | (mass %) | (mass %) |
| 11 | Comparative Example | 24.40 | 6.55 | 0.11 | 31.06 | bal. | 0.86 | 0.05 | 0.30 | 0.16 |
| 12 | Example | 24.40 | 6.55 | 0.11 | 31.06 | bal. | 0.88 | 0.05 | 0.30 | 0.16 |
| 13 | Example | 24.40 | 6.55 | 0.11 | 31.06 | bal. | 0.90 | 0.05 | 0.30 | 0.16 |
| 4 | Example | 24.40 | 6.55 | 0.11 | 31.06 | bal. | 0.92 | 0.05 | 0.30 | 0.16 |
| 14 | Example | 24.40 | 6.55 | 0.11 | 31.06 | bal. | 0.97 | 0.05 | 0.30 | 0.16 |
| 15 | Example | 24.40 | 6.55 | 0.11 | 31.06 | bal. | 1.00 | 0.05 | 0.30 | 0.16 |
| 16 | Comparative Example | 24.40 | 6.55 | 0.11 | 31.06 | bal. | 1.03 | 0.05 | 0.30 | 0.16 |

| | | | | | | Base material | | | |
|---|---|---|---|---|---|---|---|---|---|
| | | | | | | composition | Magnetic properties | | |
| | Magnet composition | | | | | Two-grain | | | Hk/ |
| Sample | Ga | Co | O | C | N | boundary | Br | HcJ | HcJ |
| No. | (mass %) | (mass %) | (mass %) | (mass %) | (mass %) | interface | (mT) | (kA/m) | (%) |
| 11 | 0.60 | 1.00 | 0.14 | 0.08 | 0.06 | Good | 1422 | 2051 | 91.6 |
| 12 | 0.60 | 1.00 | 0.14 | 0.08 | 0.06 | Good | 1426 | 2048 | 93.4 |
| 13 | 0.60 | 1.00 | 0.14 | 0.08 | 0.06 | Good | 1430 | 2033 | 94.4 |
| 4 | 0.60 | 1.00 | 0.14 | 0.08 | 0.06 | Good | 1438 | 2015 | 96.2 |
| 14 | 0.60 | 1.00 | 0.14 | 0.08 | 0.06 | Good | 1454 | 1998 | 96.6 |
| 15 | 0.60 | 1.00 | 0.14 | 0.08 | 0.06 | Good | 1458 | 1945 | 95.8 |
| 16 | 0.60 | 1.00 | 0.14 | 0.08 | 0.06 | Good | 1458 | 1854 | 95.1 |

TABLE 3

| | | Magnet composition | | | | | | | | |
|---|---|---|---|---|---|---|---|---|---|---|
| | | | | Tb | | | | | | |
| Sample | Example/ | Nd | Pr | (=TRH) | TRE | Fe | B | Zr | Cu | Al |
| No. | Comparative Example | (mass %) | (mass %) | (mass %) | (mass %) | (mass %) | (mass %) | (mass %) | (mass %) | (mass %) |
| 21 | Comparative Example | 24.40 | 6.55 | 0.11 | 31.06 | bal. | 0.92 | 0.00 | 0.30 | 0.16 |
| 22 | Example | 24.40 | 6.55 | 0.11 | 31.06 | bal. | 0.92 | 0.01 | 0.30 | 0.16 |
| 23 | Example | 24.40 | 6.55 | 0.11 | 31.06 | bal. | 0.92 | 0.04 | 0.30 | 0.16 |
| 4 | Example | 24.40 | 6.55 | 0.11 | 31.06 | bal. | 0.92 | 0.05 | 0.30 | 0.16 |
| 24 | Example | 24.40 | 6.55 | 0.11 | 31.06 | bal. | 0.92 | 0.18 | 0.30 | 0.16 |
| 25 | Example | 24.40 | 6.55 | 0.11 | 31.06 | bal. | 0.92 | 0.33 | 0.30 | 0.16 |
| 26 | Example | 24.40 | 6.55 | 0.11 | 31.06 | bal. | 0.92 | 0.43 | 0.30 | 0.16 |
| 27 | Example | 24.40 | 6.55 | 0.11 | 31.06 | bal. | 0.92 | 0.50 | 0.30 | 0.16 |
| 28 | Comparative Example | 24.40 | 6.55 | 0.11 | 31.06 | bal. | 0.92 | 0.52 | 0.30 | 0.16 |

| | | | | | | Base material | | | |
|---|---|---|---|---|---|---|---|---|---|
| | | | | | | composition | Magnetic properties | | |
| | Magnet composition | | | | | Two-grain | | | Hk/ |
| Sample | Ga | Co | O | C | N | boundary | Br | HcJ | HcJ |
| No. | (mass %) | (mass %) | (mass %) | (mass %) | (mass %) | interface | (mT) | (kA/m) | (%) |
| 21 | 0.60 | 1.00 | 0.14 | 0.08 | 0.06 | Good | 1449 | 1877 | 91.2 |
| 22 | 0.60 | 1.00 | 0.14 | 0.08 | 0.06 | Good | 1449 | 1910 | 93.6 |
| 23 | 0.60 | 1.00 | 0.14 | 0.08 | 0.06 | Good | 1444 | 1921 | 94.5 |
| 4 | 0.60 | 1.00 | 0.14 | 0.08 | 0.06 | Good | 1438 | 2015 | 96.2 |
| 24 | 0.60 | 1.00 | 0.14 | 0.08 | 0.06 | Good | 1439 | 2019 | 96.7 |
| 25 | 0.60 | 1.00 | 0.14 | 0.08 | 0.06 | Good | 1420 | 2022 | 97.0 |
| 26 | 0.60 | 1.00 | 0.14 | 0.08 | 0.06 | Good | 1408 | 2024 | 97.3 |
| 27 | 0.60 | 1.00 | 0.14 | 0.08 | 0.06 | Good | 1402 | 2028 | 97.5 |
| 28 | 0.60 | 1.00 | 0.14 | 0.08 | 0.06 | Good | 1394 | 2030 | 97.5 |

TABLE 4

| | | Magnet composition | | | | | | | | |
|---|---|---|---|---|---|---|---|---|---|---|
| | | | | Tb | | | | | | |
| Sample | Example/ | Nd | Pr | (=TRH) | TRE | Fe | B | Zr | Cu | Al |
| No. | Comparative Example | (mass %) | (mass %) | (mass %) | (mass %) | (mass %) | (mass %) | (mass %) | (mass %) | (mass %) |
| 31 | Comparative Example | 24.40 | 6.55 | 0.11 | 31.06 | bal. | 0.92 | 0.05 | 0.02 | 0.16 |
| 32 | Example | 24.40 | 6.55 | 0.11 | 31.06 | bal. | 0.92 | 0.05 | 0.04 | 0.16 |
| 33 | Example | 24.40 | 6.55 | 0.11 | 31.06 | bal. | 0.92 | 0.05 | 0.08 | 0.16 |
| 4 | Example | 24.40 | 6.55 | 0.11 | 31.06 | bal. | 0.92 | 0.05 | 0.30 | 0.16 |
| 34 | Example | 24.40 | 6.55 | 0.11 | 31.06 | bal. | 0.92 | 0.05 | 0.43 | 0.16 |
| 35 | Example | 24.40 | 6.55 | 0.11 | 31.06 | bal. | 0.92 | 0.05 | 0.50 | 0.16 |
| 36 | Comparative Example | 24.40 | 6.55 | 0.11 | 31.06 | bal. | 0.92 | 0.05 | 0.53 | 0.16 |

| | | | | | | Base material | | | |
|---|---|---|---|---|---|---|---|---|---|
| | | | | | | composition | Magnetic properties | | |
| | Magnet composition | | | | | Two-grain | | | Hk/ |
| Sample | Ga | Co | O | C | N | boundary | Br | HcJ | HcJ |
| No. | (mass %) | (mass %) | (mass %) | (mass %) | (mass %) | interface | (mT) | (kA/m) | (%) |
| 31 | 0.60 | 1.00 | 0.14 | 0.08 | 0.06 | Good | 1457 | 1877 | 93.3 |
| 32 | 0.60 | 1.00 | 0.14 | 0.08 | 0.06 | Good | 1455 | 1909 | 95.7 |
| 33 | 0.60 | 1.00 | 0.14 | 0.08 | 0.06 | Good | 1451 | 1945 | 96.6 |
| 4 | 0.60 | 1.00 | 0.14 | 0.08 | 0.06 | Good | 1438 | 2015 | 96.2 |
| 34 | 0.60 | 1.00 | 0.14 | 0.08 | 0.06 | Good | 1429 | 1988 | 94.5 |
| 35 | 0.60 | 1.00 | 0.14 | 0.08 | 0.06 | Good | 1406 | 1956 | 93.9 |
| 36 | 0.60 | 1.00 | 0.14 | 0.08 | 0.06 | Good | 1397 | 1938 | 93.5 |

TABLE 5

| | | Magnet composition | | | | | | | | |
|---|---|---|---|---|---|---|---|---|---|---|
| | | | | Tb | | | | | | |
| Sample | Example/ | Nd | Pr | (=TRH) | TRE | Fe | B | Zr | Cu | Al |
| No. | Comparative Example | (mass %) | (mass %) | (mass %) | (mass %) | (mass %) | (mass %) | (mass %) | (mass %) | (mass %) |
| 41 | Comparative Example | 24.40 | 6.55 | 0.11 | 31.06 | bal. | 0.92 | 0.05 | 0.30 | 0.16 |
| 42 | Example | 24.40 | 6.55 | 0.11 | 31.06 | bal. | 0.92 | 0.05 | 0.30 | 0.16 |
| 43 | Example | 24.40 | 6.55 | 0.11 | 31.06 | bal. | 0.92 | 0.05 | 0.30 | 0.16 |
| 4 | Example | 24.40 | 6.55 | 0.11 | 31.06 | bal. | 0.92 | 0.05 | 0.30 | 0.16 |
| 44 | Example | 24.40 | 6.55 | 0.11 | 31.06 | bal. | 0.92 | 0.05 | 0.30 | 0.16 |
| 45 | Example | 24.40 | 6.55 | 0.11 | 31.06 | bal. | 0.92 | 0.05 | 0.30 | 0.16 |
| 46 | Example | 24.40 | 6.55 | 0.11 | 31.06 | bal. | 0.92 | 0.05 | 0.30 | 0.16 |
| 47 | Comparative Example | 24.40 | 6.55 | 0.11 | 31.06 | bal. | 0.92 | 0.05 | 0.30 | 0.16 |

| | | | | | | Base material | | | |
|---|---|---|---|---|---|---|---|---|---|
| | | | | | | composition | Magnetic properties | | |
| | Magnet composition | | | | | Two-grain | | | Hk/ |
| Sample | Ga | Co | O | C | N | boundary | Br | HcJ | HcJ |
| No. | (mass %) | (mass %) | (mass %) | (mass %) | (mass %) | interface | (mT) | (kA/m | (%) |
| 41 | 0.60 | 1.00 | 0.10 | 0.08 | 0.04 | Poor | 1444 | 1855 | 95.7 |
| 42 | 0.60 | 1.00 | 0.11 | 0.08 | 0.04 | Good | 1442 | 1911 | 94.3 |
| 43 | 0.60 | 1.00 | 0.13 | 0.08 | 0.05 | Good | 1440 | 2002 | 96.0 |
| 4 | 0.60 | 1.00 | 0.14 | 0.08 | 0.06 | Good | 1438 | 2015 | 96.2 |
| 44 | 0.60 | 1.00 | 0.16 | 0.08 | 0.05 | Good | 1440 | 2025 | 97.2 |
| 45 | 0.60 | 1.00 | 0.26 | 0.08 | 0.06 | Good | 1432 | 1993 | 96.0 |
| 46 | 0.60 | 1.00 | 0.29 | 0.08 | 0.06 | Good | 1418 | 1915 | 93.5 |
| 47 | 0.60 | 1.00 | 0.32 | 0.08 | 0.06 | Poor | 1389 | 1865 | 95.9 |

TABLE 6

| | | Magnet composition | | | | | | | | |
|---|---|---|---|---|---|---|---|---|---|---|
| | | | | Tb | | | | | | |
| Sample | Example/ | Nd | Pr | (=TRH) | TRE | Fe | B | Zr | Cu | Al |
| No. | Comparative Example | (mass %) | (mass %) | (mass %) | (mass %) | (mass %) | (mass %) | (mass %) | (mass %) | (mass %) |
| 51 | Comparative Example | 24.40 | 6.55 | 0.11 | 31.06 | bal. | 0.92 | 0.05 | 0.30 | 0.16 |
| 52 | Example | 24.40 | 6.55 | 0.11 | 31.06 | bal. | 0.92 | 0.05 | 0.30 | 0.16 |
| 53 | Example | 24.40 | 6.55 | 0.11 | 31.06 | bal. | 0.92 | 0.05 | 0.30 | 0.16 |
| 4 | Example | 24.40 | 6.55 | 0.11 | 31.06 | bal. | 0.92 | 0.05 | 0.30 | 0.16 |
| 54 | Example | 24.40 | 6.55 | 0.11 | 31.06 | bal. | 0.92 | 0.05 | 0.30 | 0.16 |
| 55 | Example | 24.40 | 6.55 | 0.11 | 31.06 | bal. | 0.92 | 0.05 | 0.30 | 0.16 |
| 56 | Comparative Example | 24.40 | 6.55 | 0.11 | 31.06 | bal. | 0.92 | 0.05 | 0.30 | 0.16 |

| | | | | | | Base material | | | |
|---|---|---|---|---|---|---|---|---|---|
| | | | | | | composition | Magnetic properties | | |
| | Magnet composition | | | | | Two-grain | | | Hk/ |
| Sample | Ga | Co | O | C | N | boundary | Br | HcJ | HcJ |
| No. | (mass %) | (mass %) | (mass %) | (mass %) | (mass %) | interface | (mT) | (kA/m) | (%) |
| 51 | 0.60 | 1.00 | 0.14 | 0.04 | 0.06 | Poor | 1411 | 1824 | 95.5 |
| 52 | 0.60 | 1.00 | 0.14 | 0.05 | 0.06 | Good | 1426 | 1947 | 95.8 |
| 53 | 0.60 | 1.00 | 0.14 | 0.06 | 0.06 | Good | 1435 | 1996 | 95.7 |
| 4 | 0.60 | 1.00 | 0.14 | 0.08 | 0.06 | Good | 1438 | 2015 | 96.2 |
| 54 | 0.60 | 1.00 | 0.14 | 0.11 | 0.06 | Good | 1442 | 2008 | 95.0 |
| 55 | 0.60 | 1.00 | 0.14 | 0.12 | 0.06 | Good | 1444 | 1976 | 94.2 |
| 56 | 0.60 | 1.00 | 0.14 | 0.13 | 0.06 | Poor | 1447 | 1852 | 92.1 |

TABLE 7

| | | Magnet composition | | | | | | | | |
|---|---|---|---|---|---|---|---|---|---|---|
| | | | | Tb | | | | | | |
| Sample | Example/ | Nd | Pr | (=TRH) | TRE | Fe | B | Zr | Cu | Al |
| No. | Comparative Example | (mass %) | (mass %) | (mass %) | (mass %) | (mass %) | (mass %) | (mass %) | (mass %) | (mass %) |
| 61 | Comparative Example | 24.40 | 6.55 | 0.11 | 31.06 | bal. | 0.92 | 0.05 | 0.30 | 0.16 |
| 62 | Example | 24.40 | 6.55 | 0.11 | 31.06 | bal. | 0.92 | 0.05 | 0.30 | 0.16 |
| 63 | Example | 24.40 | 6.55 | 0.11 | 31.06 | bal. | 0.92 | 0.05 | 0.30 | 0.16 |
| 64 | Example | 24.40 | 6.55 | 0.11 | 31.06 | bal. | 0.92 | 0.05 | 0.30 | 0.16 |
| 4 | Example | 24.40 | 6.55 | 0.11 | 31.06 | bal. | 0.92 | 0.05 | 0.30 | 0.16 |
| 65 | Example | 24.40 | 6.55 | 0.11 | 31.06 | bal. | 0.92 | 0.05 | 0.30 | 0.16 |
| 66 | Comparative Example | 24.40 | 6.55 | 0.11 | 31.06 | bal. | 0.92 | 0.05 | 0.30 | 0.16 |

| | | | | | | Base material | | | |
|---|---|---|---|---|---|---|---|---|---|
| | | | | | | composition | Magnetic properties | | |
| | Magnet composition | | | | | Two-grain | | | Hk/ |
| Sample | Ga | Co | O | C | N | boundary | Br | HcJ | HcJ |
| No. | (mass %) | (mass %) | (mass %) | (mass %) | (mass %) | interface | (mT) | (kA/m) | (%) |
| 61 | 0.60 | 1.00 | 0.14 | 0.08 | 0.01 | Poor | 1443 | 1869 | 95.1 |
| 62 | 0.60 | 1.00 | 0.14 | 0.08 | 0.02 | Good | 1442 | 1970 | 95.0 |
| 63 | 0.60 | 1.00 | 0.14 | 0.08 | 0.03 | Good | 1442 | 2023 | 96.2 |
| 64 | 0.60 | 1.00 | 0.14 | 0.08 | 0.05 | Good | 1440 | 2010 | 95.9 |
| 4 | 0.60 | 1.00 | 0.14 | 0.08 | 0.06 | Good | 1438 | 2015 | 96.2 |
| 65 | 0.60 | 1.00 | 0.15 | 0.08 | 0.07 | Good | 1437 | 1976 | 96.0 |
| 66 | 0.60 | 1.00 | 0.13 | 0.08 | 0.09 | Poor | 1436 | 1842 | 94.3 |

TABLE 8

| | | Magnet composition | | | | | | | | |
|---|---|---|---|---|---|---|---|---|---|---|
| | | | | Tb | | | | | | |
| Sample | Example/ | Nd | Pr | (=TRH) | TRE | Fe | B | Zr | Cu | Al |
| No. | Comparative Example | (mass %) | (mass %) | (mass %) | (mass %) | (mass %) | (mass %) | (mass %) | (mass %) | (mass %) |
| 71 | Comparative Example | 24.40 | 6.55 | 0.00 | 30.95 | bal. | 0.92 | 0.05 | 0.30 | 0.16 |
| 71a | Comparative Example | 24.40 | 6.55 | 0.01 | 30.96 | bal. | 0.92 | 0.05 | 0.30 | 0.16 |
| 72 | Example | 24.40 | 6.55 | 0.03 | 30.98 | bal. | 0.92 | 0.05 | 0.30 | 0.16 |
| 73 | Example | 24.40 | 6.55 | 0.05 | 31.00 | bal. | 0.92 | 0.05 | 0.30 | 0.16 |
| 4 | Example | 24.40 | 6.55 | 0.11 | 31.06 | bal. | 0.92 | 0.05 | 0.30 | 0.16 |
| 74 | Example | 24.40 | 6.55 | 0.17 | 31.12 | bal. | 0.92 | 0.05 | 0.30 | 0.16 |
| 75 | Example | 24.40 | 6.55 | 0.20 | 31.15 | bal. | 0.92 | 0.05 | 0.30 | 0.16 |
| 76 | Comparative Example | 24.40 | 6.55 | 0.23 | 31.18 | bal. | 0.92 | 0.05 | 0.30 | 0.16 |
| 41 | Comparative Example | 24.40 | 6.55 | 0.11 | 31.06 | bal. | 0.92 | 0.05 | 0.30 | 0.16 |
| 77 | Comparative Example | 24.40 | 6.55 | 0.19 | 31.14 | bal. | 0.92 | 0.05 | 0.30 | 0.16 |
| 51 | Comparative Example | 24.40 | 6.55 | 0.11 | 31.06 | bal. | 0.92 | 0.05 | 0.30 | 0.16 |
| 78 | Comparative Example | 24.40 | 6.55 | 0.20 | 31.15 | bal. | 0.92 | 0.05 | 0.30 | 0.16 |

| | | | | | | Base material | | | |
|---|---|---|---|---|---|---|---|---|---|
| | | | | | | composition | Magnetic properties | | |
| | Magnet composition | | | | | Two-grain | | | Hk/ |
| Sample | Ga | Co | O | C | N | boundary | Br | HcJ | HcJ |
| No. | (mass %) | (mass %) | (mass %) | (mass %) | (mass %) | interface | (mT) | (kA/m) | (%) |
| 71 | 0.60 | 1.00 | 0.14 | 0.08 | 0.06 | Good | 1444 | 1435 | 99.5 |
| 71a | 0.60 | 1.00 | 0.14 | 0.08 | 0.06 | Good | 1443 | 1580 | 99.0 |
| 72 | 0.60 | 1.00 | 0.14 | 0.08 | 0.06 | Good | 1441 | 1907 | 97.8 |
| 73 | 0.60 | 1.00 | 0.14 | 0.08 | 0.06 | Good | 1435 | 1945 | 94.8 |
| 4 | 0.60 | 1.00 | 0.14 | 0.08 | 0.06 | Good | 1438 | 2015 | 96.2 |
| 74 | 0.60 | 1.00 | 0.14 | 0.08 | 0.06 | Good | 1434 | 2057 | 95.7 |
| 75 | 0.60 | 1.00 | 0.14 | 0.08 | 0.06 | Good | 1431 | >2060 | 95.5 |
| 76 | 0.60 | 1.00 | 0.14 | 0.08 | 0.06 | Good | 1427 | >2060 | 94.7 |
| 41 | 0.60 | 1.00 | 0.10 | 0.08 | 0.04 | Poor | 1444 | 1855 | 95.7 |
| 77 | 0.60 | 1.00 | 0.10 | 0.08 | 0.04 | Poor | 1435 | 1887 | 95.0 |
| 51 | 0.60 | 1.00 | 0.14 | 0.04 | 0.06 | Poor | 1411 | 1824 | 95.5 |
| 78 | 0.60 | 1.00 | 0.14 | 0.04 | 0.06 | Poor | 1405 | 1875 | 94.8 |

TABLE 9

| | | Magnet composition | | | | | | | | |
|---|---|---|---|---|---|---|---|---|---|---|
| | | | | Tb | | | | | | |
| Sample | Example/ | Nd | Pr | (=TRH) | TRE | Fe | B | Zr | Cu | Al |
| No. | Comparative Example | (mass %) | (mass %) | (mass %) | (mass %) | (mass %) | (mass %) | (mass %) | (mass %) | (mass %) |
| 81a | Example | 24.40 | 6.55 | 0.11 | 31.06 | bal. | 0.92 | 0.05 | 0.30 | 0.00 |
| 81 | Example | 24.40 | 6.55 | 0.11 | 31.06 | bal. | 0.92 | 0.05 | 0.30 | 0.02 |
| 82 | Example | 24.40 | 6.55 | 0.11 | 31.06 | bal. | 0.92 | 0.05 | 0.30 | 0.06 |
| 4 | Example | 24.40 | 6.55 | 0.11 | 31.06 | bal. | 0.92 | 0.05 | 0.30 | 0.16 |
| 83 | Example | 24.40 | 6.55 | 0.11 | 31.06 | bal. | 0.92 | 0.05 | 0.30 | 0.38 |
| 84 | Example | 24.40 | 6.55 | 0.11 | 31.06 | bal. | 0.92 | 0.05 | 0.30 | 0.48 |
| 85 | Example | 24.40 | 6.55 | 0.11 | 31.06 | bal. | 0.92 | 0.05 | 0.30 | 0.59 |
| 86 | Example | 24.40 | 6.55 | 0.11 | 31.06 | bal. | 0.92 | 0.05 | 0.30 | 0.16 |
| 4 | Example | 24.40 | 6.55 | 0.11 | 31.06 | bal. | 0.92 | 0.05 | 0.30 | 0.16 |
| 87 | Example | 24.40 | 6.55 | 0.11 | 31.06 | bal. | 0.92 | 0.05 | 0.30 | 0.16 |
| 88 | Example | 24.40 | 6.55 | 0.11 | 31.06 | bal. | 0.92 | 0.05 | 0.30 | 0.16 |
| 4 | Example | 24.40 | 6.55 | 0.11 | 31.06 | bal. | 0.92 | 0.05 | 0.30 | 0.16 |
| 89 | Example | 24.40 | 6.55 | 0.11 | 31.06 | bal. | 0.92 | 0.05 | 0.30 | 0.16 |

| | | | | | | Base material | | | |
|---|---|---|---|---|---|---|---|---|---|
| | | | | | | composition | Magnetic properties | | |
| | Magnet composition | | | | | Two-grain | | | Hk/ |
| Sample | Ga | Co | O | C | N | boundary | Br | HcJ | HcJ |
| No. | (mass %) | (mass %) | (mass %) | (mass %) | (mass %) | interface | (m) | (kA/m) | (%) |
| 81a | 0.60 | 1.00 | 0.14 | 0.08 | 0.06 | Good | 1448 | 1975 | 95.8 |
| 81 | 0.60 | 1.00 | 0.14 | 0.08 | 0.06 | Good | 1445 | 1997 | 96.0 |
| 82 | 0.60 | 1.00 | 0.14 | 0.08 | 0.06 | Good | 1442 | 2011 | 96.2 |
| 4 | 0.60 | 1.00 | 0.14 | 0.08 | 0.06 | Good | 1439 | 2015 | 96.3 |
| 83 | 0.60 | 1.00 | 0.15 | 0.08 | 0.06 | Good | 1432 | 2024 | 96.5 |
| 84 | 0.60 | 1.00 | 0.15 | 0.08 | 0.06 | Good | 1428 | 2030 | 96.6 |
| 85 | 0.60 | 1.00 | 0.15 | 0.08 | 0.06 | Good | 1425 | 2036 | 96.3 |
| 86 | 0.05 | 1.00 | 0.14 | 0.08 | 0.06 | Good | 1444 | 1988 | 96.1 |
| 4 | 0.60 | 1.00 | 0.14 | 0.08 | 0.06 | Good | 1439 | 2015 | 96.3 |
| 87 | 0.80 | 1.00 | 0.14 | 0.08 | 0.06 | Good | 1436 | 2030 | 96.5 |
| 88 | 0.60 | 0.50 | 0.14 | 0.08 | 0.06 | Good | 1437 | 2012 | 96.3 |
| 4 | 0.60 | 1.00 | 0.15 | 0.08 | 0.06 | Good | 1439 | 2015 | 96.3 |
| 89 | 0.60 | 3.00 | 0.15 | 0.08 | 0.06 | Good | 1440 | 2019 | 96.2 |

According to Tables 1 to 9, in each Example, in which the entire composition was within a specific range, sufficiently many intergrain interfaces were identified before grain boundary diffusion. Each Example had good magnetic properties.

According to Table 1, Sample No. 1, in which TRE (total rare earth element content) was too low, had low HcJ and low Hk/HcJ. Sample No. 7, in which TRE was too high, had low Hk/HcJ.

According to Table 2, Sample No. 11, in which the B content was too low, had low Hk/HcJ. Sample No. 16, in which the B content was too high, had low HcJ.

According to Table 3, Sample No. 21, in which Zr was not contained, had low HcJ and low Hk/HcJ. Sample No. 28, in which the Zr content was too high, had low Br.

According to Table 4, Sample No. 31, in which the Cu content was too low, had low HcJ. Sample No. 36, in which the Cu content was too high, had low Br.

According to Table 5, neither in Sample No. 41 with too low an O content or Sample No. 47 with too high an O content, the intergrain interfaces in the base material were sufficiently identified. Sample No. 41 had low HcJ. Sample No. 47 had low Br and low HcJ.

According to Table 6, neither in Sample No. 51 with too low a C content or Sample No. 56 with too high a C content, the intergrain interfaces in the base material were sufficiently identified. Sample No. 51 had low HcJ. Sample No. 56 had low HcJ and low Hk/HcJ.

According to Table 7, neither in Sample No. 61 with too low a N content or Sample No. 66 with too high a N content, the intergrain interfaces in the base material were sufficiently identified. Both Sample Nos. 61 and 66 had low HcJ.

According to Table 8, Sample No. 71, in which grain boundary diffusion of Tb was not carried out, had low HcJ. In Sample No. 76, in which TRH (total heavy rare earth element content) was too high, the heavy rare earth element content was not sufficiently low. Sample No. 76 also had lower Hk/HcJ than that of each Example with sufficiently low TRH.

According to Table 8, even when TRE of Sample No. 41 with too low an O content and TRE of Sample No. 51 with too low a C content were increased so as to be about the same as TRE of Sample No. 75, the intergrain interfaces in the base material were not sufficiently identified. Moreover, HcJ did not sufficiently improve.

R-T-B based permanent magnets of Sample Nos. 90 to 97 were manufactured under substantially the same conditions as those of Sample No. 4 except that conditions of the first aging treatment were changed.

Similarly to other samples, a SEM image of the resultant R-T-B based permanent magnets was obtained. A freely selected region measuring 20 μm×15 μm in a field of view of the SEM image was subject to observation. The selected region of the SEM image subject to observation was binarized using image processing software. From an image resulting from binarization, the total area ratio of low-melting-point grain boundary phases and the average circle equivalent diameter of the low-melting-point grain boundary phases were calculated.

Table 10 shows the oxygen content, the carbon content, the nitrogen content, first aging treatment conditions, various parameters of the microstructure, and magnetic properties of each sample. Conditions other than the first aging treatment conditions were similar to those of Sample No. 4.

TABLE 10

| | | | | | | | | Low-melting-point | | | | |
|---|---|---|---|---|---|---|---|---|---|---|---|---|
| | | | | | | | Base | grain boundary phase | | | | |
| | | | | | | | material | Average | | | | |
| | | | | | First aging | | composition | circle | Total | Magnetic properties | | |
| | Example/ | Magnet composition | | | treatment condition | | Two-grain | equivalent | area | | | Hk/ |
| Sample | Comparative | O | C | N | Temperature | Time | boundary | diameter | ratio | Br | HcJ | HcJ |
| No. | Example | (mass %) | (mass %) | (mass %) | (° C.) | (h) | interface | (μm) | (%) | (mT) | (kA/m) | (%) |
| 90 | Example | 0.14 | 0.08 | 0.06 | 800 | 2.0 | Good | 0.34 | 1.1 | 1439 | 1944 | 96.5 |
| 91 | Example | 0.13 | 0.08 | 0.05 | 850 | 2.0 | Good | 0.59 | 3.5 | 1439 | 1984 | 96.3 |
| 4 | Example | 0.14 | 0.08 | 0.06 | 900 | 2.0 | Good | 0.76 | 5.3 | 1439 | 2015 | 96.3 |
| 92 | Example | 0.13 | 0.08 | 0.06 | 950 | 2.0 | Good | 0.92 | 6.6 | 1436 | 1993 | 96.0 |
| 93 | Example | 0.15 | 0.08 | 0.06 | 1000 | 2.0 | Good | 1.13 | 7.9 | 1428 | 1937 | 95.7 |
| 94 | Example | 0.14 | 0.08 | 0.05 | 900 | 1.0 | Good | 0.46 | 1.3 | 1439 | 1932 | 95.5 |
| 95 | Example | 0.14 | 0.07 | 0.05 | 900 | 1.5 | Good | 0.51 | 5.0 | 1439 | 1991 | 96.0 |
| 4 | Example | 0.14 | 0.08 | 0.06 | 900 | 2.0 | Good | 0.76 | 5.3 | 1439 | 2015 | 96.3 |
| 96 | Example | 0.15 | 0.08 | 0.06 | 900 | 10 | Good | 0.88 | 5.9 | 1437 | 1989 | 96.1 |
| 97 | Example | 0.14 | 0.08 | 0.05 | 900 | 15 | Good | 1.04 | 6.8 | 1436 | 1945 | 95.7 |

According to Table 10, in each Example, in which the entire composition was within the specific range, sufficiently many intergrain interfaces were identified before grain boundary diffusion. Each Example had good magnetic properties.

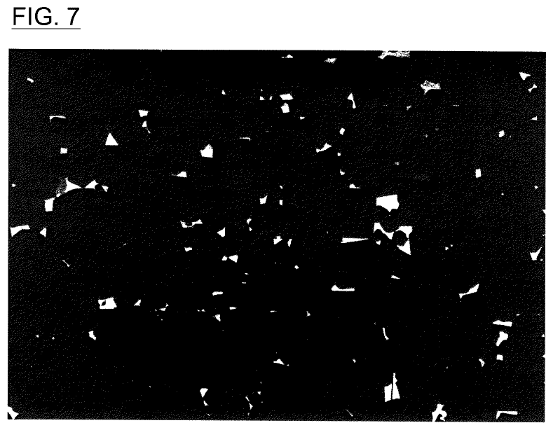

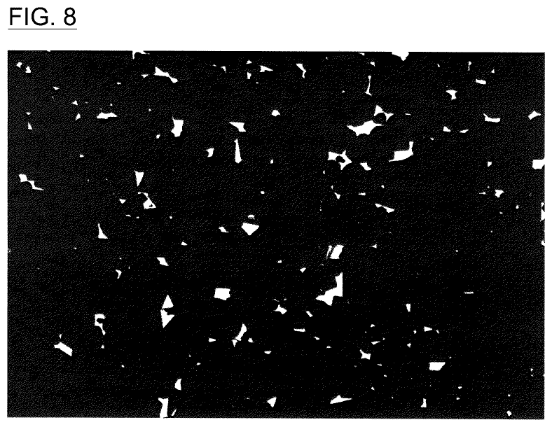

FIG. 7 is an image resulting from binarization of the SEM image shown as FIG. 2 (SEM image of the base material of Sample No. 4 at a magnification of ×2500). FIG. 8 is an image resulting from binarization of the SEM image shown as FIG. 4 (SEM image of the base material of Sample No. 63 at a magnification of ×2500). FIGS. 7 and 8 reveal that the magnets of Sample Nos. 4 and 63, in which the predetermined first aging treatment was performed, had a good dispersion state of triple junctions.

As shown in Table 10, the R-T-B based permanent magnets of Sample Nos. 91, 4, 92, and 94 to 96, in which the average circle equivalent diameter of the low-melting-point grain boundary phases was 0.40 μm or more and 1.00 μm or less or the area ratio of the low-melting-point grain boundary phases was 1.5% or more and 7.5% or less, had improved HcJ while maintaining high Br.

In particular, the R-T-B based permanent magnets of Sample Nos. 91, 4, 92, and 95 to 96, in which the average circle equivalent diameter of the low-melting-point grain boundary phases was 0.40 μm or more and 1.00 μm or less and the total area ratio of the low-melting-point grain boundary phases was 1.5% or more and 7.5% or less, had improved HcJ while maintaining high Br.

Note that, particularly the magnet of Sample No. 63, in which the first aging treatment was performed as in Sample No. 4, also had an average circle equivalent diameter of the low-melting-point grain boundary phases of 0.40 μm or more and 1.00 μm or less and a total area ratio of the low-melting-point grain boundary phases of 1.5% or more and 7.5% or less, having improved HcJ while maintaining high Br.

### REFERENCE NUMERALS

1 . . . R-T-B based permanent magnet

What is claimed is:

1. An R-T-B based permanent magnet comprising a rare earth element, Fe, Zr, Cu, B, C, O, and N,
wherein
the R-T-B based permanent magnet comprises
28.50 mass % or more and 32.00 mass % or less rare earth element,
0.01 mass % or more and 0.50 mass % or less Zr,
0.04 mass % or more and 0.50 mass % or less Cu,
0 mass % or more and 0.60 mass % or less Al,
0 mass % or more and 0.80 mass % or less Ga,
0 mass % or more and 3.50 mass % or less Co,
0.88 mass % or more and 1.00 mass % or less B,
0.05 mass % or more and 0.12 mass % or less C,
0.11 mass % or more and 0.30 mass % or less O,
0.015 mass % or more and 0.07 mass % or less N, and
Fe substantially constituting a balance of the R-T-B based permanent magnet,
the rare earth element includes a heavy rare earth element, and
the R-T-B based permanent magnet comprises 0.03 mass % or more and 0.20 mass % or less heavy rare earth element.

2. The R-T-B based permanent magnet according to claim 1, having a remanent magnetic flux density Br of 1400 mT or more and a coercivity HcJ of 1900 kA/m or more.

3. The R-T-B based permanent magnet according to claim 1, wherein
the R-T-B based permanent magnet comprises main phases and triple junctions surrounded by three or more of the main phases,
the triple junctions comprise rare earth oxide phases and low-melting-point grain boundary phases, and
the low-melting-point grain boundary phases have an average circle equivalent diameter of 0.40 μm or more and 1.00 μm or less.

4. The R-T-B based permanent magnet according to claim 3, wherein the low-melting-point grain boundary phases occupy a total area ratio of 1.5% or more and 7.5% or less.

5. A method of manufacturing an R-T-B based permanent magnet, comprising:
pulverizing an alloy to provide an alloy powder;
compression-molding the alloy powder to provide a green compact;
sintering the green compact to provide a sintered body; and
heat treating the sintered body with a diffusing material comprising a heavy rare earth element in contact therewith,
wherein an oxygen content of the alloy powder is controlled before the alloy powder is compression-molded.

6. The method of manufacturing an R-T-B based permanent magnet according to claim 5, wherein
the alloy is coarsely pulverized using hydrogen storage pulverization to provide a coarse powder, and
the coarse powder is finely pulverized to provide the alloy powder.

7. The method of manufacturing an R-T-B based permanent magnet according to claim 6, wherein the coarse powder is finely pulverized using a jet mill.

8. The method of manufacturing an R-T-B based permanent magnet according to claim 6, wherein the coarse powder is heat treated in an atmosphere having an oxygen concentration of 0.5% or more and 23% or less to control the oxygen content of the alloy powder.

9. The method of manufacturing an R-T-B based permanent magnet according to claim 7, wherein the coarse powder is finely pulverized using the jet mill with an inside atmosphere having an oxygen concentration of 0.01% or more and 0.30% or less to control the oxygen content of the alloy powder.

10. The method of manufacturing an R-T-B based permanent magnet according to claim 7, wherein the coarse powder is finely pulverized using the jet mill with an inside atmosphere comprising a mixed gas of a noble gas and an oxygen gas to control the oxygen content of the alloy powder.

11. The method of manufacturing an R-T-B based permanent magnet according to claim 7, wherein the coarse powder is
heat treated in an atmosphere having an oxygen concentration of 0.5% or more and 23% or less, and
finely pulverized using the jet mill with an inside atmosphere comprising a mixed gas of a noble gas and an oxygen gas or comprising a noble gas,
to control the oxygen content of the alloy powder.

12. The method of manufacturing an R-T-B based permanent magnet according to claim 5, comprising performing a first aging treatment for the sintered body before and/or after heat treating the sintered body with the diffusing material comprising the heavy rare earth element in contact therewith.

13. The method of manufacturing an R-T-B based permanent magnet according to claim 12, comprising performing the first aging treatment before heat treating the sintered body with the diffusing material comprising the heavy rare earth element in contact therewith.

14. The method of manufacturing an R-T-B based permanent magnet according to claim 12, wherein the first aging treatment is performed at an aging treatment temperature of 850° C. or more and 950° C. or less for an aging treatment time of 1.5 hours or more and 10 hours or less.

15. The method of manufacturing an R-T-B based permanent magnet according to claim 12, further comprising performing a second aging treatment for the sintered body after the first aging treatment.

16. The method of manufacturing an R-T-B based permanent magnet according to claim 15, comprising performing the second aging treatment after heat treating the sintered body with the diffusing material comprising the heavy rare earth element in contact therewith.
